(19) United States
(12) Patent Application Publication
(10) Pub. No.: US 2008/0131686 A1
(43) Pub. Date: Jun. 5, 2008

(54) Environmentally friendly wear resistant carbide coating

(75) Inventor: Christopher W. Strock, Kennebunk, ME (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/634,057

(22) Filed: Dec. 5, 2006

(51) Int. Cl. B32B 9/00

(52) U.S. Cl. 428/332; 428/698

(57) ABSTRACT

A component positioned proximate a mating surface includes a surface facing the mating element and a wear resistant coating positioned on the surface of the substrate. The coating includes a filler material and an environmentally friendly matrix material. The matrix material has a crystal structure of at least one of a ternary carbide, a ternary nitride, and a carbo-nitride.

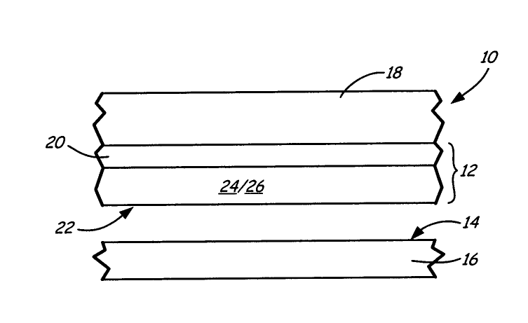

### BACKGROUND OF THE INVENTION

The present invention generally relates to the field of tribological coatings. In particular, the present invention relates to a wear resistant coating for a part of a gas turbine engine.

Hard, wear resistant coatings are often used in gas turbine engines for wear resistance where mating surfaces are subject to fretting wear. Due to the harsh environment of gas turbine engines, the engine components are preferably coated with hard chromium plating, nickel plating, or a variety of metal alloy, ceramic, and metal matrix carbide thermally sprayed coatings. While effective, there are potential disadvantages to all of these methods. Plating processes are generally not environmentally friendly due to the use of acids and toxic plating solutions. Most of the chromium used contains hexavalent chromium, which is considered hazardous waste. An alternative to plating process would also be beneficial due to the high cost and environmental concerns relating to plating. Lastly, thermally sprayed hard coatings are complex and expensive to machine to desired final tolerances and surface finishes, usually requiring superabrasive grinding.

Consideration must also be given to the effect that the abradable material may have on downstream components of the gas turbine engine when the surface comes into contact with a mating surface and the hard coating has been worn from the surface and is flowing through the gas turbine engine.

### BRIEF SUMMARY OF THE INVENTION

A component positioned proximate a mating surface includes a surface facing the mating element and a wear resistant coating positioned on the surface of the substrate. The coating includes a filler material and an environmentally friendly matrix material. The matrix material has a crystal structure of at least one of a ternary carbide, a ternary nitride and a carbo-nitride.

### BRIEF DESCRIPTION OF THE DRAWINGS

The sole FIGURE is side view of a component positioned proximate a mating surface of an adjacent component.

### DETAILED DESCRIPTION

The sole FIGURE shows a side view of component 10 having wear resistant coating 12 positioned proximate mating surface 14 of an adjacent component 16. Component 10 having wear resistant coating 12 improves the efficiency and operating costs of a gas turbine engine by being readily machined using a single point cutting tool and being highly wear resistant to fretting wear. In addition, wear resistant coating 12 may be of varying purity and levels of decarburization and oxidation depending on the severity of the application environment. This is accomplished in part by using a lower density coating and a more thermally stable coating material that is easier to manufacture than traditional hard, wear resistant coatings. Due to its brittle fracture mode below temperatures of approximately 1200° C., component 10 is also capable of reducing damage to other components located downstream in the gas turbine engine by resisting chipping and galling, and turning to dust with wear. Although wear resistant coating 12 is discussed as being used with a gas engine turbine, wear resistant coating 12 may be used in any application requiring a wear resistant coating.

Wear resistant coating 12 is applied onto substrate 18 of component 10. Substrate 18 provides a base for wear resistant coating 12, which faces mating surface 14 of adjacent component 16. In an exemplary embodiment, substrate 18 may be formed of metal, ceramic, or composite material. Wear resistant coating 12 may be a two layer system with bond coat 20 and composite layer 22. Composite layer 22 is formed by a ternary carbide, ternary nitride, or carbo-nitride matrix material 24 and a filler material 26. Bond coat 20 is used only when additional adhesion is needed between substrate 18 and composite layer 22.

Matrix material 24 of wear resistant coating 12 may be applied as a dense single phase layer or as a composite on substrate 18 and bond coat 20. Matrix material 24 has a layered crystal structure at an atomic scale and has highly anisotropic properties on a molecular level. Matrix material 24 is also interconnected with itself, and holds filler material 26 within wear resistant coating 12. The performance of ternary carbide or nitride matrix material 24 is also unique in that it is independent of the purity of the ternary carbide, ternary nitride, or carbo-nitride material. Thus, some thermal decomposition and oxidation may be tolerated.

Examples of suitable matrix materials include, but are not limited to: ternary carbides, ternary nitrides, or carbo-nitrides. Examples of particularly suitable matrix materials include, but are not limited to: M₂X₁Z₁, wherein M is at least one transition metal, X is an element selected from the group consisting of: Al, Ge, Pb, Sn, Ga, P, S, In, As, TI, and Cd, and Z is a non-metal selected from the group consisting of C and N; M₃X₁Z₂, wherein M is at least one transition metal, X is at least one of: Si, Al, Ge, and Z is a non-metal selected from the group consisting of C and N; and M₄X₁Z₃, wherein M is at least one transition metal, X is Si, and Z is N. An example of a particularly suitable metallic matrix material is Ti₃SiC₂. The matrix materials listed above are disclosed and described in detail in “Microstructure and mechanical properties of porous Ti₃SiC₂”, published online on Jul. 14, 2005, by Z. M. Sun, A. Murugaiah, T. Zhen, A. Zhou, and M. W. Barsoum; “Mechanical Properties of MAX Phases” published in 2004 by Encyclopedia of Materials Science and Technology, Eds. by Buschow, Cahn, Flemings, Kramer, Mahajan, and Veyssiere, Elsevier Science; and “The MAX Phases: Unique New Carbide and Nitride Materials”, published in July-August 2001, by Michel W. Barsoum and Tamer El-Raghy.

The atomic layers within the matrix material 24 are layers of hard, strong, high modulus carbide. The atoms are also arranged in layers so that they form very weak crystallographic planes. Thus, both high modulus strong planes and very weak planes are present in matrix material 24. This results in kink band forming tendencies, which gives it both ceramic and metallic properties. When matrix material 24 deforms, there is slip between the atomic planes of the molecules, forming kink bands. This kink band forming tendency provides for high toughness and elongation to failure, resulting in resistance to handling and impact damage. The kink bands provide toughness similar to a metal, making matrix material 24 capable of withstanding impact damage conditions while the high modulus and high hardness of the carbide layers make matrix material 24 capable of withstanding fine particle erosion and fretting wear. At the same time, the slip planes have low strength such that matrix material 24 is capable of being machined using a sharp cutting point. For example, matrix material 24 may be machined by conventional single point cutting tool with operating parameters similar to those used for metals.

Filler material 26 of wear resistant coating 12 acts as an inert material that may also contribute to the desired properties of wear resistant coating 12. For example, filler material 26 may be used to fill pores for aerodynamics or substrate corrosion protection, to modify the strength or toughness of wear resistant coating 12, or to modify the characteristics of matrix material 24. In an exemplary embodiment, filler material 26 of wear resistant coating 12 may include, but are not limited to: pure metals, alloyed metals, intermetallics, oxide ceramics, glasses, carbides, nitrides, carbon, graphite, organics, or polymers. Examples include, but are not limited to: thermal decomposition and oxidation products of the ternary carbide which may be pure or mixed oxides or sub-stoichiometric carbides; nickel or cobalt or alloys thereof; copper or copper based alloys; nichrome (a Ni Cr alloy); monel (a Cu Ni alloy); aluminides, aluminum and aluminum based alloys; amorphous alloys; alumina; titania; zirconia; metal oxide ceramics and mixtures and alloys thereof; bentonite clay; silica; tungsten carbide and tungsten carbide with a Ni, Co, Ni—Co—Cr matrix; chromium carbide and chromium carbide with a Ni—Cr or Co matrix; metallic carbides; organic binders or fillers; Lucite; polyester; Teflon (PTFE); polypropylene; and polyethylene, low molecular weight polyethylene, high molecular weight polyethylene; and ultra high molecular weight polyethylene.

In an exemplary embodiment, matrix material 24 preferably constitutes between approximately 50% and approximately 100% of wear resistant coating 12 by volume. Matrix material 24 more preferably constitutes between approximately 75% and approximately 95% of composite layer 22 by volume. Matrix material 24 most preferably constitutes between approximately 85% and approximately 95% of composite layer 22 by volume. Thus, although wear resistant coating 12 is discussed as including a filler material 26, wear resistant coating 12 may also optionally be comprised solely of matrix material 24.

Composite layer 22 of component 10 may be applied to substrate 18 and bond coat 20 by any suitable method known in the art. Examples of suitable methods include, but are not limited to: plasma spraying, wire arc spraying, flame spraying, and high velocity oxygen fuel spraying. In an exemplary embodiment, composite layer 22 is applied onto bond coat 20 to a thickness of between approximately 50 microns and approximately 2000 microns. In an exemplary embodiment, matrix material 24 is applied to bond coat 20 by plasma spraying and filler material 26 is applied to bond coat 20 simultaneously by injecting it into the plasma spray plume through a separate powder injection port. In another exemplary embodiment, matrix material 24 and filler material 26 are blended to create a mixture that is fed through a single port. In another exemplary embodiment, composite powder particles containing both matrix material 24 and filler material 26 make up the feedstock.

Due to its metallic characteristics, such as toughness, ductility, and moderate strength, component 10 having wear resistant coating 12 may be subjected to abusive environments and handling without being chipped or damaged. In addition, the metallic properties of wear resistant coating 12 permit component 10 to be machined using a conventional single point cutting tool. This is beneficial because machining components with conventional tools using operating parameters similar to the operating parameters used to machine metal is less costly and time-consuming than using complex, specialized equipment. In operation, as component 10 engages mating surface 14 of adjacent component 16 or is struck by a tool or object, the kink band formation of wear resistant coating 12 provides resistance to chipping and bulk damage to component 10. For example, component 10 and adjacent component 16 may be two flanges having a snap diameter that are bolted together. During manufacture and assembly, brittle coatings are susceptible to chipping when its edges come into contact with mating parts or tools, or accidentally come into contact with other foreign materials.

While component 10 exhibits desirable metallic characteristics, component 10 also exhibits desirable ceramic characteristics. Due to small, vibratory motions between component 10 and adjacent component 16, fretting wear may become an issue. Wear resistant coating 12 on component 10 serves to increase the resistance to fretting wear. In addition, due to its brittle fracture mode, as composite layer 20 of wear resistant coating 12 is worn from substrate 18, the material turns to dust, rather than chips, preventing damage to any downstream components. In addition, damage to mating surface 14 of adjacent component 16 is prevented by the non-abrasive characteristics of wear debris, and lack of coating smearing and galling of wear resistant coating 12. In addition, the ceramic characteristics of wear resistant coating 12 result in low erosion rates when subjected to fine particle erosion. Any wear debris is also environmentally friendly, as it does not contain any chromium.

The component is positioned proximate a mating surface of an adjacent component and includes a substrate and a wear resistant composite coating applied on a top surface of the substrate. The wear resistant composite coating includes a ternary carbide matrix material or a ternary nitride matrix material and a filler material that does not react with the matrix material or the environment. By using the ternary carbide or ternary nitride matrix material rather than an iron, cobalt, or nickel-based alloy, the overall weight of the component is reduced and the thermal cycle durability of the component is increased. This is due to the low material density, low coefficient of thermal expansion, and high toughness of the composite. The wear resistant composite coating also increases the wear resistance of the component when the mating surface of the adjacent component engages the wear resistant composite coating of the component. In addition, because the matrix material exhibits high impact resistance and toughness, a lower volume fraction of the matrix material is required. The matrix material of the wear resistant coating of the component provides both metallic and ceramic characteristics to the component, balancing the need for erosion control and machinability. The metallic properties of the component allow for high durability to impact damage, while the ceramic characteristics provide erosion and fretting wear resistance. The ceramic brittle wear mechanical properties of the component allow for non-smearing, non-burr formation, and harmless dust formation as the wear debris.

Although the present invention has been described with reference to preferred embodiments, workers skilled in the art will recognize that changes may be made in form and detail without departing from the spirit and scope of the invention.

1. A component positioned proximate a mating element, the component comprising:
a surface facing the mating element; and
a wear resistant coating positioned on the surface of the substrate, wherein the coating comprises a filler material and an environmentally friendly matrix material having a crystal structure of at least one of: a ternary carbide, a ternary nitride, and a carbo-nitride.

2. The component of claim 1, wherein the matrix material constitutes between about 85% and about 95% of the wear resistant coating by volume.

3. The component of claim 1, wherein the wear resistant coating is applied to the surface by thermal spraying.

4. The component of claim 1, and further comprising a bond coat positioned between the surface and the wear resistant coating.

5. The component of claim 1, wherein the wear resistant coating is between about 50 microns and about 2000 microns thick.

6. The component of claim 1, wherein the matrix material comprises at least one of the group consisting of:
M₂X₁Z₁, wherein M is at least one transition metal, X is an element selected from the group consisting of: Al, Ge, Pb, Sn, Ga, P, S, In, As, TI, and Cd, and Z is a non-metal selected from the group consisting of C and N;
M₃X₁Z₂, wherein M is at least one transition metal, X is at least one of: Si, Al, Ge, and Z is a non-metal selected from the group consisting of C and N; and
M₄X₁Z₃, wherein M is at least one transition metal, X is Si, and Z is N.

7. The component of claim 6, wherein the matrix material is Ti₃SiC₂.

8. A component having improved wear resistance and positioned for engaging a mating surface, the component comprising:
a substrate; and
a wear resistant coating applied on the substrate comprising:
a filler material; and
a matrix material, wherein the material comprises at least one of the group consisting of:
M₂X₁Z₁, wherein M is at least one transition metal, X is an element selected from the group consisting of: Al, Ge, Pb, Sn, Ga, P, S, In, As, TI, and Cd, and Z is a non-metal selected from the group consisting of C and N;
M₃X₁Z₂, wherein M is at least one transition metal, X is at least one of: Si, Al, Ge, and Z is a non-metal selected from the group consisting of C and N; and
M₄X₁Z₃, wherein M is at least one transition metal, X is Si, and Z is N.

9. The component of claim 8, wherein the matrix material constitutes between about 75% and about 95% of the wear resistant coating by volume.

10. The component of claim 9, wherein the matrix material constitutes between about 85% and about 95% of the wear resistant coating by volume.

11. The component of claim 8, and further comprising a bond coat positioned between the substrate and the wear resistant coating.

12. The component of claim 8, wherein matrix material is selected from the group consisting of: a ternary carbide, a ternary nitride, and a carbo-nitride.

13. The component of claim 8, wherein the matrix material is Ti₃SiC₂.

14. The component of claim 8, wherein performance of the wear resistant coating is independent of purity of the matrix material.

15. A wear-resistant component for resisting fretting wear, the wear-resistant component comprising:
a substrate positioned to engage an adjacent component;
a bond coat positioned on the substrate; and
a wear resistant coating positioned on the bond coat, wherein the wear resistant coating includes a matrix material and a filler material, wherein the wear resistant coating is sprayed onto the substrate.

16. The wear-resistant component of claim 15, wherein the matrix material comprises at least one of the group consisting of:
M₂X₁Z₁, wherein M is at least one transition metal, X is an element selected from the group consisting of: Al, Ge, Pb, Sn, Ga, P, S, In, As, TI, and Cd, and Z is a non-metal selected from the group consisting of C and N;
M₃X₁Z₂, wherein M is at least one transition metal, X is at least one of: Si, Al, Ge, and Z is a non-metal selected from the group consisting of C and N; and
M₄X₁Z₃, wherein M is at least one transition metal, X is Si, and Z is N.

17. The wear-resistant component of claim 15, wherein the matrix material is selected from the group consisting of: a ternary carbide, a ternary nitride, and a carbo-nitride.

18. The wear-resistant component of claim 17, wherein the matrix material is Ti₃SiC₂.

19. The wear-resistant component of claim 15, wherein the matrix material constitutes between about 75% and about 95% of the wear resistant coating by volume.

20. The wear-resistant component of claim 19, wherein the matrix material constitutes between about 85% and about 95% of the wear resistant coating by volume.
